(19) United States
(12) Patent Application Publication
(10) Pub. No.: US 2014/0022705 A1
(43) Pub. Date: Jan. 23, 2014

(54) ELECTROCONDUCTIVE POLYMER SOLUTION, ELECTROCONDUCTIVE POLYMER MATERIAL AND METHOD FOR PRODUCING SAME, AND SOLID ELECTROLYTIC CAPACITOR

(71) Applicants: Yasuhiro Tomioka, Sendai-shi (JP); Tomoki Nobuta, Sendai-shi (JP); Yasuhisa Sugawara, Sendai-shi (JP); Yuji Yoshida, Sendai-shi (JP); Satoshi Suzuki, Sendai-shi (JP)

(72) Inventors: Yasuhiro Tomioka, Sendai-shi (JP); Tomoki Nobuta, Sendai-shi (JP); Yasuhisa Sugawara, Sendai-shi (JP); Yuji Yoshida, Sendai-shi (JP); Satoshi Suzuki, Sendai-shi (JP)

(73) Assignee: NEC Tokin Corporation, Miyagi (JP)

(21) Appl. No.: 14/110,351

(22) PCT Filed: Apr. 9, 2012
(86) PCT No.: PCT/JP2012/059693

§ 371 Date: Oct. 7, 2013

(30) Foreign Application Priority Data
Apr. 8, 2011 (JP) 2011-086368

(51) Int. Cl. H01G 9/028

(52) U.S. Cl. CPC H01G 9/028
USPC 361/526; 252/62.2

(57) ABSTRACT

This is to provide an electroconductive polymer material which has excellent adhesion to a base and excellent water resistance. Also, this is to provide a solid electrolytic capacitor which has excellent water resistance by using the same. An electroconductive polymer solution according to the present invention contains an electroconductive polymer, at least one water-soluble multivalent alcohol, and at least one oxoacid having two or more hydroxy groups. Since a resin obtained by carrying out a polycondensation reaction of the water-soluble multivalent alcohol and the oxoacid has a cross-linked structure, an electroconductive polymer having lower water-absorbing property and more excellent water resistance in comparison with a resin having a linear structure can be obtained.

### TECHNICAL FIELD

The present invention relates to an electroconductive polymer solution, an electroconductive polymer material obtained from the solution, and a solid electrolytic capacitor using the same.

### BACKGROUND ART

Electroconductive polymer materials are used for electrodes of condensers, electrodes of dye-sensitization solar cells, electrodes of electroluminescence displays, and the like. As the electroconductive polymer material, polymer materials obtained by polymerizing pyrrole, thiophene, 3,4-ethylenedioxythiophene, aniline, or the like are known.

Patent document 1 discloses a polythiophene solution which contains water or a mixture of a water-miscible organic solvent and water as a dispersing solvent, a polythiophene having structural units of 3,4-dialkoxy thiophene, and a polyanion derived from a polystyrene sulfonic acid having a molecular weight of 2,000 to 500,000, and a method for producing the same. In Patent document 1, the polythiophene is obtained by oxidation chemical polymerization of a polystyrene sulfonic acid having a molecular weight of 2,000 to 500,000 in a presence of a polyanion.

Also, Patent document 2 discloses a water dispersion of a complex of a poly(3,4-dialkoxy thiophene) and a polyanion, and a method for producing the same, as well as a coating composition containing the water dispersion and a coated base material having a transparent electroconductive film on which the composition is applied.

Also, Patent document 3 discloses a technology concerning an aqueous antistatic coating composition.

### PRIOR ART DOCUMENT

### Patent Document

Patent document 1: JP 7-90060 A

Patent document 2: JP 2004-59666 A

Patent document 3: JP 2002-60736 A

### SUMMARY OF THE INVENTION

### Problem to be Solved by the Invention

The polythiophene solution disclosed in Patent document 1 or 2 can be obtained by an oxidation chemical polymerization of 3,4-dialkoxy thiophene in the presence of a polyanion which acts as a dopant, but the control of the dope ratio is difficult. The electroconductive polymer material containing an undoped polyanion has high water-absorbing property because the polyanion is hydrophilic.

In general when an electroconductive polymer material having high wafer-absorbing property or a complex thereof is used as an electrode material, the electrode is swelled or contracted by changing the humidity of the environment and the adhesion to the base material may be decreased. Therefore, in the electrode material using an electroconductive polymer material or a complex thereof, there is a problem in reliability in a high humidity atmosphere.

Also, in Patent document 3, a self-emulsified polyester resin aqueous dispersion formed by a polycondensation reaction of a dicarboxylic acid component and a diol component is contained, and thereby the adhesion to a base material and the water resistance of a coated film can be improved. However, since the self-emulsified polyester resin is dispersed in the water solvent, the segregation in the antistatic coating composition easily occurs. If a portion where a resin does not exist is formed in the antistatic coating composition by the segregation, since a partial swelling occurs in a water resistant test, the water dispersion type resin as mentioned above may have partially decreased water resistance.

From the above, the problem of the present invention is to provide an electroconductive polymer material which has excellent water resistance and a high electroconductivity. Also, it is to provide a solid electrolytic capacitor which has a low equivalent series resistance (hereinafter, referred to as ESR) and excellent adhesion to a substrate.

### Means of Solving the Problem

An electroconductive polymer solution according to the present invention contains: an electroconductive polymer, at least one water-soluble multivalent alcohol, and at least one oxoacid having two or more hydroxy groups.

An electroconductive polymer material according to the present invention is a material which is obtained by drying the electroconductive polymer solution according to the present invention to remove a solvent.

A method for producing the electroconductive polymer material according to the present invention includes carrying out a polycondensation reaction of the water-soluble multivalent alcohol and the oxoacid at 80° C. to 130° C.

A solid electrolytic capacitor according to the present invention has a solid electrolyte containing an electroconductive polymer material which is obtained by drying the electroconductive polymer solution according to the present invention to remove a solvent.

### Effect of the Invention

By the electroconductive polymer solution according to the present invention, an electroconductive polymer material which has excellent wafer resistance and a high electroconductivity can be obtained. Also, by the electroconductive polymer material according to the present invention, a solid electrolytic capacitor which has a low ESR, excellent adhesion to a substrate, and excellent reliability particularly in a high-humidity atmosphere can be obtained.

### BRIEF DESCRIPTION OF DRAWING

FIG. 1 is a schematic sectional view showing a conformation of a solid electrolytic capacitor according to the present invention.

### MODE FOR CARRYING OUT THE INVENTION

As follows, an electroconductive polymer solution according to the present invention, an electroconductive polymer material obtained from the electroconductive polymer solution, and a solid electrolytic capacitor using the same are explained in detail.

### (Electroconductive Polymer Solution)

An electroconductive polymer solution according to the present invention contains an electroconductive polymer, at least one water-soluble multivalent alcohol, and at least one oxoacid having two or more hydroxy groups. Note that, the electroconductive polymer solution in the present invention is in a state where the electroconductive polymer is dissolved or dispersed in a solvent.

The water-soluble multivalent alcohol denotes an alcohol having a valence of 2 or more which has solubility or dispensability to water. The water-soluble multivalent alcohol preferably has a valence of 4 or more. Examples of the water-soluble multivalent alcohol contained in the electroconductive polymer solution include, for example, ethylene glycol, butylene glycol, propylene glycol, 3-methyl-1,3-butanediol, hexylene glycol, diethylene glycol, dipropylene glycol, glycerin, diglycerin, inositol, xylose, glucose, mannitol, trehalose, erythritol, xylitol, sorbitol, pentaerythritol, polyethylene glycols, polypropylene glycols, and polyvinyl alcohols. This may be used alone or in combination with two or more kinds.

Among these, the water-soluble multivalent alcohol is preferably at least one selected from the group consisting of hydrophilic resins, erythritol, and pentaerythritol. Also, the water-soluble multivalent alcohol is preferably a mixture of a hydrophilic resin with erythritol and/or pentaerythritol.

If erythritol and/or pentaerythritol are mixed as the water-soluble multivalent alcohol, the electroconductive polymer material interacts with an undoped polyacid anion existing near the electroconductive polymer material in the electroconductive polymer solution, and thereby the electroconductivity of the electroconductive polymer material is improved.

Also, if erythritol and/or pentaerythritol that is a water-soluble multivalent alcohol having a valence of 3 or more are used, the resin obtained by a polycondensation reaction of an oxoacid having two or more hydroxy groups and a water-soluble multivalent alcohol has a cross-linked structure. This leads to obtaining an electroconductive polymer material having not only excellent water-absorbing property and water resistance, but also excellent adhesion to a base material.

Further, if a mixture of a hydrophilic resin with erythritol and/or pentaerythritol is used as the water-soluble multivalent alcohol, a mixed structure of cross-linked structure and linear structure can be obtained by containing the hydrophilic resin, and thereby the adhesion to a base material and the water resistance are further improved. The hydrophilic resin denotes a polymer of an alcohol having a valence of 2 or more which has solubility or dispersibility to water. Examples of the hydrophilic resin include polyvinyl alcohols and polymers of multivalent alcohols such as ethylene vinyl alcohol. This may be used alone or in combination with two or more kinds. Among these, the hydrophilic resin is preferably a polyvinyl alcohol. The weight average molecular weight of the hydrophilic resin is preferably 1000 to 20000. Note that, the weight average molecular weight of the hydrophilic resin is a value measured by GPC (gel permeation chromatograph).

When the hydrophilic resin is used alone, the adhesion is improved but the water resistance is low. However, by using it with an oxoacid having two or more hydroxy groups, a hydroxy group of the hydrophilic resin and a hydroxy group of the oxoacid is polycondensed at the time of drying to form an ether bond. This leads to obtaining an electroconductive polymer material which is insoluble in water and which has excellent adhesion to a base material.

Examples of the oxoacid having two or more hydroxy groups include boric acid, phosphoric acid, sulfuric acid, chromic acid, and derivatives or salts thereof. This may be used alone or in combination with two or more kinds. Among these, the oxoacid having two or more hydroxy groups is preferably at least one selected from the group consisting of boric acid, phosphoric acid, sulfuric acid, and derivatives or salts thereof. The oxoacid having two or more hydroxy groups is more preferably at least one selected from the group consisting of boric acid, derivatives of boric acid and salts of boric acid. This is because there is one unoccupied p orbital of boron and an oxygen atom of a water-soluble multivalent alcohol is easily coordinated thereto. Boric acid, derivatives of boric acid, salts of boric acid, and mixtures thereof are changed to a borate resin by a polycondensation reaction with a water-soluble multivalent alcohol.

The mixing amount of the water-soluble multivalent alcohol and the oxoacid having two or more hydroxy groups is preferably in a range of 1 to 400 parts by mass with respect to 100 parts by mass of the electroconductive polymer in the electroconductive polymer solution, is more preferably in a range of 20 to 200 parts by mass, and is further preferably n a range of 50 to 100 parts by mass.

The electroconductive polymer is not particularly limited, but examples thereof include polythiophenes, polypyrroles, polyanilines, polyacetylenes, poly(p-phenylene)s, poly(p-phenylene vinylene)s, poly(thienylene vinylene)s, and derivatives thereof. Among these, the electroconductive polymer is preferably a polymer having a repeating unit of 3,4-ethylenedioxythiophene or a derivative thereof from the standpoint of the heat stability.

As a dopant of the electroconductive polymer, a polyacid which functions as a dopant to the electroconductive polymer can be used. Specific examples of the polyacid include polyacryl resins having a substituted or non-substituted sulfonic acid group such as poly(2-acrylamide-2-methylpropane sulfonic acid)s, polyvinyl resins having a substituted or non-substituted sulfonic acid group such as polyvinyl sulfonic acids, polystyrene resins having a substituted or non-substituted sulfonic acid group such as polystyrene sulfonic acids, polyester resins having a substituted or non-substituted sulfonic acid group such as polyester sulfonic acids, and copolymers containing one or more kinds selected from these. This may be used alone or in combination with two or more kinds. Among these, the polyacid is preferably a polystyrene sulfonic acid.

The weight average molecular weight of the polyacid is preferably 2,000 to 500,000, is more preferably 5,000 to 300,000, and is further preferably 10,000 to 200,000, from the standpoint of improving the dispersibility and the electroconductivity. The weight average molecular weight of the polyacid is a value measured by GPC (gel permeation chromatograph).

The concentration of the electroconductive polymer contained in the electroconductive polymer solution is preferably 0.1 to 20 wt % with respect to the total solution amount, and is more preferably 0.5 to 10 wt %, from the standpoint of the dispersibility.

For example, water, a mixture of a wafer-miscible organic solvent and water, or the like can be used as the solvent contained in the electroconductive polymer solution. Specific examples of the organic solvent include alcohol solvents such as methanol, ethanol, and propanol, aromatic hydrocarbon solvents such as benzene, toluene, and xylene, aliphatic hydrocarbon solvents such as hexane, aprotic polar solvents such as N,N-dimethylformamide, dimethylsulfoxide, acetonitrile, and acetone. The organic solvent can be used alone, or in combination with two or more kinds. The organic solvent preferably contains at least one selected from water/alcohol solvents and aprotic polar solvents.

### (Electroconductive Polymer Material)

An electroconductive polymer material according to the present invention can be obtained by drying the electroconductive polymer solution according to the present invention to remove a solvent. Since the water-soluble multivalent alcohol and the oxoacid having two or more hydroxy groups are completely dissolved in the solvent, and the polycondensation reaction thereof occurs in the drying process, a water-insoluble resin can be formed with no segregation in the electroconductive polymer material. By the effect of the wafer-insoluble resin formed with no segregation in the electroconductive polymer material, an electroconductive polymer material having excellent adhesion to a base material and excellent water resistance can be obtained. In the electroconductive polymer material, a hydroxy group of the water-soluble multivalent alcohol and a hydroxy group of the oxoacid is polycondensed to form an ether bond.

For example, the electroconductive polymer material can be produced by carrying out a polycondensation reaction of the water-soluble multivalent alcohol and the oxoacid having two or more hydroxy groups at 80° C. to 130° C. and thereafter by drying the solution to remove a solvent. The temperature of the polycondensation reaction is preferably 80° C. to 105° C. The drying temperature is not particularly limited as long as it is a temperature equal to or lower than the decomposition temperature of the electroconductive polymer, but is preferably 80° C. or higher and 300° C. or lower. Note that, in the step of the polycondensation reaction, the solvent can be removed by drying the solution with carrying out the polycondensation reaction.

(Solid Electrolytic Capacitor using Electroconductive Polymer Material)

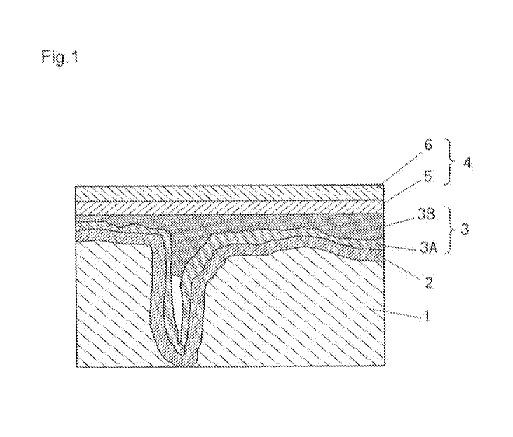

A solid electrolytic capacitor according to the present invention has a solid electrolyte containing an electroconductive polymer material which is obtained by drying the electroconductive polymer solution according to the present invention to remove a solvent. As follows, the constitution and the production method of the solid electrolytic capacitor according to the present invention are described. FIG. 1 is a schematic sectional view showing a conformation of a solid electrolytic capacitor according to the present invention. In FIG. 1, dielectric layer 2, solid electrolyte layer 3, and cathode conductor 4 are formed on anode conductor 1 in this order, which lead to forming a capacitor element.

Here, anode conductor 1 is formed of: a plate, a foil, or a wire of a metal having valve action; a sintered body containing a metal fine particle having valve action; a porous body of a metal having valve action which is subjected to a surface area enlargement treatment by etching; or the like. Examples of the valve metal include tantalum, aluminum, titanium, niobium, zirconium, and alloys thereof. Among these, at least one valve metal selected from tantalum, aluminum, and niobium is preferable.

Dielectric layer 2 is a film formed by an electrolytic oxidation of the surface of anode conductor 1, and is also formed in the pores of a sintered body or a porous body. The thickness of dielectric layer 2 can be appropriately adjusted by the voltage of the electrolytic oxidation.

Solid electrolyte layer 3 contains at least an electroconductive polymer material according to the present invention. The electroconductive polymer material may contain an electroconductive polymer of pyrrole, thiophene, aniline, or a derivative thereof; an oxide derivative such as manganese dioxide or ruthenium oxide, or an organic semiconductor such as TCNQ (7,7,8,8-tetracyanoquinodimethane) complex salt.

Solid electrolyte layer 3 can be obtained by carrying out an application or an impregnation of the electroconductive polymer solution according to the present invention on dielectric layer 2 which is formed on the surface of anode conductor 1 containing valve metal and by drying it.

Alternatively first electroconductive polymer compound layer 3A is formed on dielectric layer 2 which is formed on the surface of anode conductor 1 containing valve metal by carrying out a chemical oxidation polymerization or an electro-polymerization of a monomer such as pyrrole, a dopant, and an oxidant (a metal salt or a sulfate). The dopant is preferably a sulfonic acid compound selected from the group consisting of naphthalenesulfonic acid, benzenesulfonic acid, phenolsulfonic acid, styrenesulfonic acid, and derivatives thereof. As for the molecular weight of the dopant, it can appropriately be selected from monomers and high molecular weight compounds and can be used. As the solvent, it is possible to use water or a mixed solvent containing a water-soluble organic solvent. After that, second electroconductive polymer compound layer 3B may be formed by carrying out an application or an impregnation of the electroconductive polymer solution according to the present invention on first electroconductive polymer compound layer 3A and by drying it.

Cathode conductor 4 is not particularly limited as long as it is a conductor, but may have a two-layered conformation consisting of carbon layer 5 such as graphite and silver electroconductive resin layer 6.

The process for producing a solid electrolytic capacitor can include carrying out a polycondensation reaction of a water-soluble multivalent alcohol and an oxoacid having two or more hydroxy groups preferably at 80° C. or higher and 130° C. or lower, more preferably at 80° C. or higher and or lower. The drying temperature after the polycondensation reaction is not particularly limited as long as it is in a temperature range at which the solvent can be removed, but is preferably lower than 300° C. in order to prevent the deterioration of the capacitor element by heat. The drying time needs to be appropriately optimized by the drying temperature, but is not particularly limited as long as the electroconductivity is not damaged.

### EXAMPLES

As follows, the present embodiment is more concretely explained based on the Examples, but the present embodiment is not limited to only these Examples.

### Example 1

The polythiophene solution was produced by dissolving a polystyrene sulfonic acid having a weight average molecular weight of 50,000 (5 g), 3,4-ethylenedioxy thiophene (1.25 g), and iron (III) sulfate (0.125 g) in water (50 ml), and by introducing air for 24 hours. Erythritol (5 g), pentaerythritol (1.25 g), and boric acid (1.0 g) were added to 50 g of the polythiophene solution produced, and was completely dissolved by stirring it at room temperature for 24 hours. By this, an electroconductive polymer solution was obtained. 15 μl of the electroconductive polymer solution obtained was dropped on a glass substrate, and a polycondensation reaction was carried out in a thermostatic oven at 80° C. Then, the temperature of the thermostatic oven was changed to 125° C., and the solvent was completely volatilized and dried to produce an electroconductive polymer film.

### Example 2

An electroconductive polymer solution was prepared and an electroconductive polymer film was produced in the same manner as in Example 1 except that erythritol (5 g) and boric acid (1.0 g) were added to 50 g of the polythiophene solution produced in the same manner as in Example 1.

### Example 3

An electroconductive polymer solution was prepared and an electroconductive polymer film was produced in the same manner as in Example 1 except that a polyvinyl alcohol (1.0 g), erythritol (5 g), and boric acid (1.0 g) were added to 50 g of the polythiophene solution produced in the same manner as in Example 1.

### Example 4

An electroconductive polymer solution was prepared and an electroconductive polymer film was produced in the same manner as in Example 1 except that a polyvinyl alcohol (1.0 g) and boric acid (1.0 g) were added to 50 g of the polythiophene solution produced in the same manner as in Example 1.

### Comparative Example 1

An electroconductive polymer solution was prepared and an electroconductive polymer film was produced in the same manner as in Example 1 except that any of erythritol (5 g), pentaerythritol (1.25 g), and boric acid (1.0 g) were not added to 50 g of the polythiophene solution produced in the same manner as in Example 1.

Grit cuts were made on the surfaces of the electroconductive polymer films produced in Examples 1 to 4 and Comparative Example 1 so as to penetrate the film. After that, a tape was strongly attached on the grit part and was detached, and the film condition was observed (cross-cut test method). By this cross-cut test method, the adhesion of the electroconductive polymer film was evaluated. Also, after the sample was immersed in wafer at 23° C. for 10 minutes, the swelling and the peeling of the sample surface were observed (tap water immersing method). By the tap water immersing method, the wafer resistance of the electroconductive polymer film was evaluated.

TABLE 1

| | |
|---|---|
| | water resistance |
| adhesion | (tap water |
| (cross-cut | immersing method) |

| | test method) | swelling | peeling |
|---|---|---|---|
| Ex. 1 | A | A | A |
| Ex. 2 | A | B | A |
| Ex. 3 | A | A | A |
| Ex. 4 | A | A | A |
| Comp. Ex. 1 | C | C | C |

A: no peeling, no swelling
B: partial peeling, partial swelling
C: peeling, swelling

TABLE 1 shows comparisons of the adhesions and the water resistances of the electroconductive polymer films in Examples 1 to 4 and Comparative Example 1. From TABLE 1, it is understood that the adhesions and the water resistances of the electroconductive polymer films in Examples 1 to 4 are excellent in comparison with Comparative Example 1.

In Examples 1 and 2, since the resin obtained by the polycondensation reaction of erythritol and/or pentaerythritol, which was a water-soluble multivalent alcohol having a valence of 3 or more, with boric acid had a cross-linked structure, the water-absorbing property became low and the water resistance was improved.

In general, the water resistance of only a polyvinyl alcohol is low because of the hydrophilic property of the hydroxy group. However, in Examples 3 and 4, since a hydroxy group of the boric acid was bonded to the hydroxy group of the polyvinyl alcohol to reduce the hydrophilic property the water resistance was excellent.

Note that, in Example 3, since the polyvinyl alcohol functioned as a resin, the adhesion to a base material was excellent. Here, in the case of the water dispersion type resin, since a portion where a resin does not exist is generated due to the segregation, a partial swelling or the like is observed. On the other hand, in the Examples of the present invention, since the peeling and the swelling were not observed, if is understood that the resin is uniformly formed.

### Example 5

An anode conductor which consists of a porous aluminum foil with 3×4 mm subjected to a surface area enlargement treatment by etching was alternately immersed in and taken out from a monomer liquid, which was obtained by dissolving 10 g of pyrrole that was a monomer in 200 ml of pure water, and a solution, which was obtained by dissolving 30 g of para-toluenesulfonic acid iron (III) salt that was a dopant and an oxidant in 200 ml of pure water. These operations were repeated 10 times and a chemical oxidation polymerization was carried out to form first electroconductive polymer compound layer 3A. Then, the electroconductive polymer solution prepared in Example 1 was dropped on first electroconductive polymer compound layer 3A, and a polycondensatlon reaction was carried out in a thermostatic oven at 90° C. Further, by changing the temperature of the thermostatic oven to 125° C., it was dried and solidified to form second electroconductive polymer compound layer 3B. After that, on second electroconductive polymer compound layer 3B, a graphite layer and a silver-containing resin layer were formed in this order to produce a solid electrolytic capacitor.

### Example 6

A solid electrolytic capacitor was produced in the same manner as in Example 5 except that the electroconductive polymer solution prepared in Example 2 was used.

### Example 7

A solid electrolytic capacitor was produced in the same manner as in Example 5 except that the electroconductive polymer solution prepared in Example 3 was used.

### Example 8

A solid electrolytic capacitor was produced in the same manner as in Example 5 except that the electroconductive polymer solution prepared in Example 4 was used.

### Comparative Example 2

A solid electrolytic capacitor was produced in the same manner as in Example 5 except that the electroconductive polymer solution prepared in Comparative Example 1 was used.

In order to confirm the effect of the present invention, ESRs of the solid electrolytic capacitors produced in Examples 5 to 8 and Comparative Example 2 were measured and evaluated. As the ESR, the ESR at 100 kHz was measured using E4980A precision LCR meter (trade name, made by Agilent Technologies, Inc.). When the ESR Increasing ratio was a value obtained by dividing the ESR after keeping in an environment at a temperature of 60° C. and a humidity of 95 % for 500 hours by the ESR before keeping, the ESR increasing ratios of the solid electrolytic capacitors were compared as the evaluation of the ESR.

TABLE 2

| | ESR increasing |
|---|---|
| | ratio (%) |
| Ex. 5 | 2.0 |
| Ex. 6 | 3.0 |
| Ex. 7 | 1.7 |
| Ex. 8 | 1.8 |
| Comp. Ex. 2 | 8.0 |

TABLE 2 shows comparisons of the ESR increasing ratios of the solid electrolytic capacitors produced in Examples 5 to 8 and Comparative Example 2. From TABLE 2, the ESR of Comparative Example 2 was increased to 8.0 times by keeping in a high humidity environment. On the other hand, the ESR increasing ratios of Examples 5 to 8 were 1.7 times to 3.0 times, and it is found that the increase of the ESR is reduced. This shows that the solid electrolytic capacitor according to the present invention has excellent adhesion of the anode body and the solid electrolyte layer and has excellent water resistance of the solid electrolyte layer. Also, these correspond to the evaluation results of the water resistances of the electroconductive polymer materials of TABLE 1. That is, the solid electrolytic capacitor using the electroconductive polymer material according to the present invention has excellent humidity resistance.

In particular, the ESR increasing ratios of Examples 7 and 8 were lower than a quarter of Comparative Example 2, and the ESR increasing ratio is largely reduced. This is because a mixed structure of cross-linked structure and linear structure can be obtained by containing a hydrophilic resin in the solid electrolyte layer, and the adhesion of the anode body and the solid electrolyte layer and the water resistance of the solid electrolyte layer has been further improved.

### REFERENCE SIGNS LIST

1 anode conductor

2 dielectric layer

3 solid electrolyte layer

3A first electroconductive polymer compound layer

3B second electroconductive polymer compound layer

4 cathode conductor

5 carbon layer

6 silver electroconductive resin layer

1. An electroconductive polymer solution, comprising: an electroconductive polymer, at least one water-soluble multivalent alcohol, and at least one oxoacid having two or more hydroxy groups.

2. The electroconductive polymer solution according to claim 1, wherein the oxoacid is at least one selected from the group consisting of boric acid, phosphoric acid, sulfuric acid, and derivatives or salts thereof.

3. The electroconductive polymer solution according to claim 1, wherein the water-soluble multivalent alcohol is at least one selected from the group consisting of hydrophilic resins, erythritol and pentaerythritol.

4. The electroconductive polymer solution according to claim 1, wherein the wafer-soluble multivalent alcohol is a mixture of a hydrophilic resin with erythritol and/or pentaerythritol.

5. The electroconductive polymer solution according to claim 3, wherein the hydrophilic resin is a polyvinyl alcohol.

6. The electroconductive polymer solution according to claim 1, wherein the electroconductive polymer is a polymer comprising a repeating unit of 3,4-ethylenedioxy thiophene or a derivative thereof, and wherein the electroconductive polymer solution further comprises a polyacid.

7. The electroconductive polymer solution according to claim 6, wherein the polyacid is a polystyrene sulfonic acid.

8. The electroconductive polymer solution according to claim 7, wherein the polyacid is a polystyrene sulfonic acid having a weight average molecular weight of 2,000 to 50,000 which is calculated by GPC measurement.

9. An electroconductive polymer material, obtained by drying the electroconductive polymer solution according to claim 1 to remove a solvent.

10. The electroconductive polymer material according to claim 9, wherein a hydroxy group of the water-soluble multivalent alcohol and a hydroxy group of the oxoacid is polycondensed to form an ether bond.

11. A method for producing the electroconductive polymer material according to claim 9, comprising carrying out a polycondensation reaction of the water-soluble multivalent alcohol and the oxoacid at 80° C. to 130° C.

12. A solid electrolytic capacitor, comprising a solid electrolyte comprising an electroconductive polymer material which is obtained by drying the electroconductive polymer solution according to claim 1 to remove a solvent.
